(19) United States
(12) Patent Application Publication
(10) Pub. No.: US 2016/0226380 A1
(43) Pub. Date: Aug. 4, 2016

(54) SEMICONDUCTOR DEVICE

(71) Applicant: Kabushiki Kaisha Toshiba, Tokyo (JP)

(72) Inventor: Kazuya Matsumoto, Himeji Hyogo (JP)

(21) Appl. No.: 14/823,499

(22) Filed: Aug. 11, 2015

(30) Foreign Application Priority Data
Jan. 29, 2015 (JP) 2015-015831

(51) Int. Cl. H02M 3/158; G05F 1/575

(52) U.S. Cl. CPC H02M 3/158; G05F 1/575

(57) ABSTRACT

A semiconductor device according to an embodiment includes an input part receiving power from a power supply or a regulator and an output part outputting power to a load. A first switching element is connected between the input part and the output part and supplies power from the input part to the output part. A second switching element is connected in parallel with the first switching element between the input part and the output part and supplies power from the input part to the output part. A first controller brings the second switching element to a conduction state after bringing the first switching element to a conduction state when power is to be supplied to the load.

### CROSS REFERENCE TO RELATED APPLICATIONS

This application is based upon and claims the benefit of priority from the prior Japanese Patent Application No. 2015-015831, filed on Jan. 29, 2015, the entire contents of which are incorporated herein by reference.

### FIELD

The embodiments of the present invention relate to a semiconductor device.

### BACKGROUND

A power supply circuit used in a portable terminal or the like uses an LDO (Low Drop Out) regulator or a DC-to-DC converter to supply desired stable power to a load. The power supply circuit executes switching control of power from the LDO regulator or the DC-to-DC converter to a load using an inverter circuit. However, when the load capacitance is large, a large inrush current flows at the time of switching and an output voltage from the LDO regulator or the DC-to-DC converter transitionally decreases.

### BRIEF DESCRIPTION OF THE DRAWINGS

FIG. 1 is a block diagram showing an example of a configuration of a power supply part 1 according to a first embodiment;

FIG. 2 shows an example of an internal configuration of the load switch circuit LSW1 according to the first embodiment;

FIG. 3 shows an example of an internal configuration of the first controller 20 according to the first embodiment;

FIG. 4 is a graph showing a current Isw at the time of switching;

FIG. 5 shows an example of an internal configuration of the first controller 20 according to a second embodiment; and

FIG. 6 shows an example of an internal configuration of the first controller 20 according to a third embodiment.

### DETAILED DESCRIPTION

Embodiments will now be explained with reference to the accompanying drawings. The present invention is not limited to the embodiments.

A semiconductor device according to an embodiment includes an input part receiving power from a power supply or a regulator and an output part outputting power to a load. A first switching element is connected between the input part and the output part and supplies power from the input part to the output part. A second switching element is connected in parallel with the first switching element between the input part and the output part and supplies power from the input part to the output part. A first controller brings the second switching element to a conduction state after bringing the first switching element to a conduction state when power is to be supplied to the load.

### First Embodiment

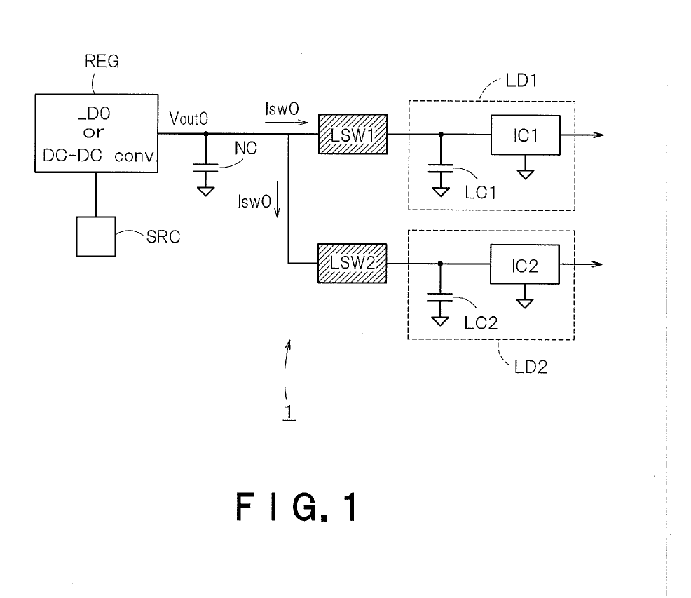

FIG. 1 is a block diagram showing an example of a configuration of a power supply part 1 according to a first embodiment. The power supply part 1 supplies power to an electric device such as a portable terminal or a personal computer. The power supply part 1 includes a power source SRC, a regulator REG, a capacitor NC, and load switch circuits LSW1 and LSW2.

The power source SRC can be, for example, a battery or a commercial power supply and is used to supply power to loads LD1 and LD2. The regulator REG is, for example, an LDO regulator or a DC-to-DC converter and is provided to stably supply predetermined power to the loads LD1 and LD2. The regulator REG supplies a predetermined current Isw0 at a predetermined voltage Vout0 to the load switch circuits LSW1 and LSW2. The capacitor NC is provided to remove high-frequency noise from source power.

The load switch circuit LSW1 is connected between the regulator REG and the load LD1 and supplies power from the regulator REG to the load LD1 or interrupts supply of the power. That is, the load switch circuit LSW1 executes switching control of power supply to the load LD1. In other words, the load switch circuit LSW1 controls switching operation of power supply to the load LD1.

The load switch circuit LSW2 is connected between the regulator REG and the load LD2 and supplies the power from the regulator REG to the load LD2 or interrupts supply of the power. That is, the load switch circuit LSW2 executes switching control of power supply to the load LD2. In other words, the load switch circuit LSW2 controls switching operation of power supply to the load LD2. Internal configurations of the load switch circuits LSW1 and LSW2 can be the same. In the first embodiment, the power supply part 1 includes the two load switch circuits LSW1 and LSW2. However, the power supply part 1 can include one load switch circuit or can include three or more load switch circuits.

The loads LD1 and LD2 are arbitrary loads provided in electric devices, respectively, and operate upon reception of supply of power from the power supply part 1. In this example, the load LD1 has a load capacitance LC1 and an integrated circuit IC1 and the load LD2 has a load capacitance LC2 and an integrated circuit IC2.

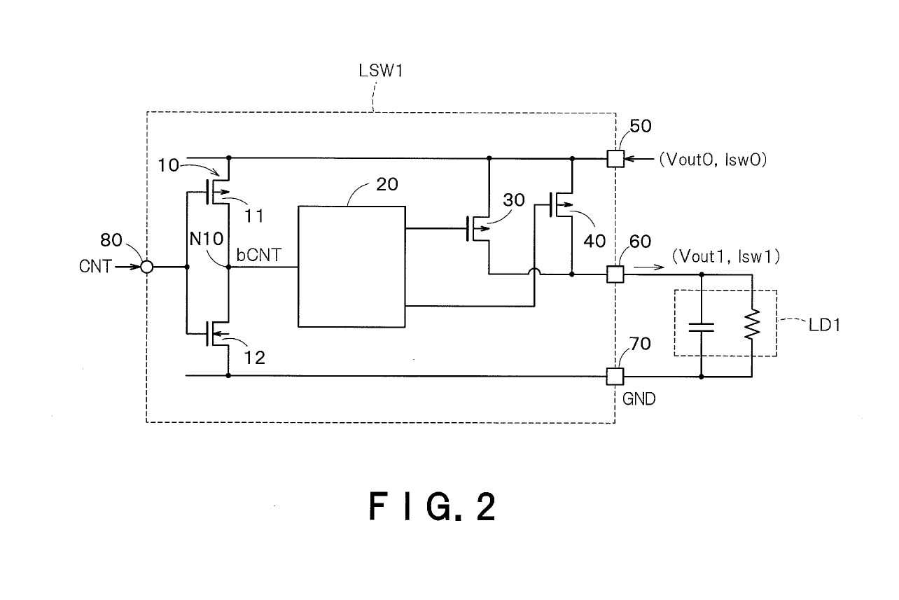

FIG. 2 shows an example of an internal configuration of the load switch circuit LSW1 according to the first embodiment. Because the load switch circuit LSW2 can have the same configuration as that of the load switch circuit LSW1, detailed explanations thereof are omitted.

The load switch circuit LSW1 includes an inverter 10, a first controller 20, a first switching element 30, a second switching element 40, an input part 50, an output part 60, a ground part 70, and a control-signal input part 80. The load switch circuit LSW1 can be constituted, for example, of one semiconductor chip.

The input part 50 receives power from the power source SRC or the regulator REG in FIG. 1 as an input. For example, the input part 50 receives the current Isw0 at the voltage Vout0 as an input. The load LD1 is connected between the output part 60 and the ground part 70. The output part 60 outputs, for example, a current Isw1 at a voltage Vout1 to the load LD1. The load switch circuit LSW1 is provided to perform switching of the power (Vout0, Isw0) from the power source SRC or the regulator REG to the load LD1. Therefore, after switching, the voltage Vout1 gradually becomes close to the voltage Vout0 and the current Isw1 gradually becomes close to the current Isw0.

The first switching element 30 is connected between the input part 50 and the output part 60 and supplies power from the input part 50 to the output part 60. The first switching element 30 can be, for example, a P-MOSFET (Metal Oxide Semiconductor Field Effect Transistor). A gate of the first switching element 30 is connected to the first controller 20.

The second switching element 40 is connected between the input part 50 and the output part 60 in parallel with the first switching element 30. The second switching element 40 also can be, for example, a P-MOSFET. A gate of the second switching element 40 is also connected to the first controller 20 similarly to the first switching element 30.

A current drive capability of the first switching element 30 is smaller than that of the second switching element 40. Alternatively, a time constant of the first switching element 30 is larger than that of the second switching element 40. That is, an on-resistance of the first switching element 30 is larger than that of the second switching element 40. For example, in order to set the current drive capability of the first switching element 30 to be smaller than that of the second switching element 40, it suffices to set a size (a channel width W/a channel length L (W/L)) of the first switching element 30 to be smaller than that of the second switching element 40. When power is to be supplied to the load LD1, the first switching element 30 having a relatively small current drive capability is first brought to a conduction state and then the second switching element 40 having a relatively large current drive capability is brought to a conduction state. The load switch circuit LSW1 thereby can gradually supply power to the load LD1 and suppress an inrush current at the time of switching.

The first and second switching elements 30 and 40 can be N-MOSFETs. However, it is preferable that the first and second switching elements 30 and 40 are P-MOSFETs having relatively high current drive capabilities. It is alternatively possible that the first switching element 30 having a relatively small current drive capability is constituted of an N-MOSFET and that the second switching element 40 having a relatively large current drive capability is constituted of a P-MOSFET. The current drive capabilities of the first switching element 30 and the second switching element 40 can be set to be different from each other by thus setting the conductivity types thereof to be different from each other. However, when the first switching element 30 or the second switching element 40 is constituted of an N-MOSFET, control signals for the first switching element 30 and the second switching element 40 need to have opposite logic.

The first controller 20 is connected between an output of the inverter 10 and the first and second switching elements 30 and 40. The first controller 20 controls operation timings of the first and second switching elements 30 and 40 upon reception of the output of the inverter 10. For example, when logic of the output of the inverter 10 is inverted to supply power to the load LD1, the first controller 20 brings the first switching element 30 to a conduction state and then brings the second switching element 40 to a conduction state. That is, when power is to be supplied to the load LD1, the first controller 20 first brings the first switching element 30 having a relatively small current drive capability to a conduction state and then brings the second switching element 40 having a relatively large current drive capability to a conduction state. This causes the load switch circuit LSW1 to bring the current Isw1 to be closer to the current Isw0 and to bring the voltage Vout1 to be closer to the voltage Vout0 while slowly charging the load LD1 without causing a large current to instantaneously flow to the load LD1. As a result, the load switch circuit LSW1 can suppress an inrush current at the time of switching and can supply the voltage Vout0 in a more stable state to the load LD1.

The inverter 10 serving as a second controller includes a P-MOSFET 11 and an N-MOSFET 12 connected in series between the input part 50 and the ground part 70 serving as a reference voltage source. Gates of the P-MOSFET 11 and the N-MOSFET 12 are connected in common to the control-signal input part 80 and perform a switching operation upon reception of a control signal CNT. A node N10 between the P-MOSFET 11 and the N-MOSFET 12 is connected to the first controller 20. Accordingly, upon reception of the control signal CNT, the inverter 10 applies an inversion signal bCNT (a logic high (Vout0) or a logic low (a ground voltage GND)) of the control signal CNT to the first controller 20. The inversion signal bCNT is hereinafter referred to also as “control signal”. The first controller 20 thus controls switching operation (or executes switching control) of the first and second switching elements 30 and 40 based on the control signal bCNT. That is, the inverter 10 can control switching operation (or execute switching control) of the first and second switching elements 30 and 40 via the first controller 20.

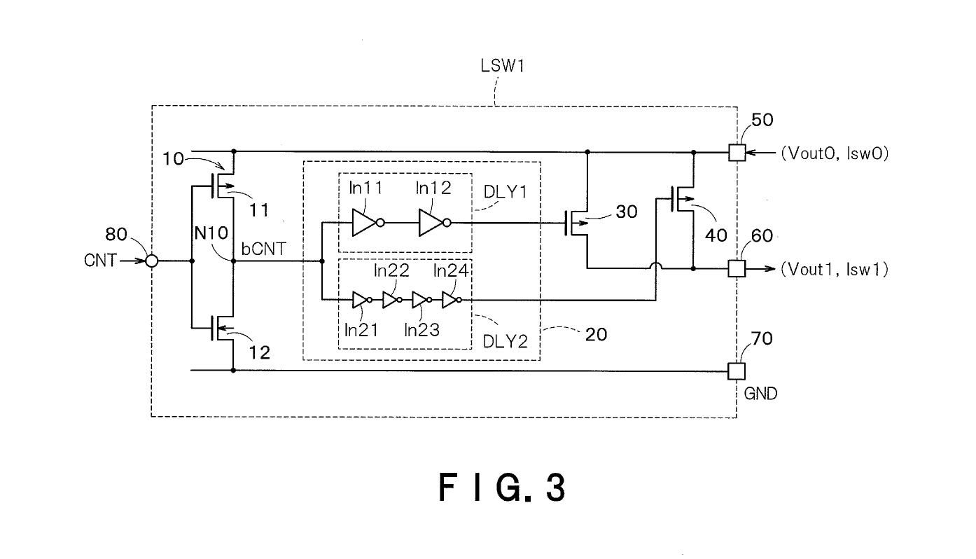

FIG. 3 shows an example of an internal configuration of the first controller 20 according to the first embodiment. In the first embodiment, the first controller 20 includes a first delay circuit DLY1 and a second delay circuit DLY2.

The first delay circuit DLY1 includes two inverters In11 and In12 connected between the node N10 of the inverter 10 and the gate of the first switching element 30. The inverters In11 and In12 are connected in series between the node N10 and the first switching element 30. The first delay circuit DLY1 thereby outputs the control signal bCNT to the first switching element 30 after a predetermined delay time.

The second delay circuit DLY2 includes four inverters In21 to In24 connected between the node N10 of the inverter 10 and the gate of the second switching element 40. The inverters In21 to In24 are connected in series between the node N10 and the second switching element 40. The number (four) of the inverters In21 to In24 included in the second delay circuit DLY2 is thus larger than the number (two) of the inverters In11 and In12 included in the first delay circuit DLY1. Accordingly, the second delay circuit DLY2 outputs the control signal bCNT to the second switching element 40 later than the first delay circuit DLY1. The number of inverters in the first delay circuit DLY1 can be smaller than two and the number of inverters in the second delay circuit DLY2 can be larger than four.

For example, when the load switch circuit LSW1 supplies power to the load LD1, the control signal CNT is activated to a logic high. At that time, the inverter 10 outputs a logic low as the control signal bCNT to the first controller 20. The first delay circuit DLY1 sends a signal of the same logic as that of the control signal bCNT to the first switching element 30 in a relatively short time. Accordingly, the first switching element 30 is first brought to a conduction state and supplies a current from the input part 50 to the output part 60. Meanwhile, the second delay circuit DLY2 sends a signal of the same logic as that of the control signal bCNT to the second switching element 40 in a time longer than that in the first delay circuit DLY1. The second switching element 40 is thereby brought to a conduction state later than the first switching element 30 and supplies a current from the input part 50 to the output part 60.

The current drive capability of the first switching element 30 is smaller than that of the second switching element 40. Because the first switching element 30 is first brought to a conduction state, the first switching element 30 then causes a relatively small current to flow from the input part 50 to the output part 60. Therefore, even when the load capacitance LC1 of the load LD1 is large, the load switch circuit LSW1 causes a relatively small current to gradually flow to the load LD1 without causing a relatively large current to quickly flow to the load LD1.

When the second switching element 40 is then brought to a conduction state, the second switching element 40 causes a relatively large current to flow from the input part 50 to the output part 60. Therefore, the second switching element 40 charges the load LD1 in a short time.

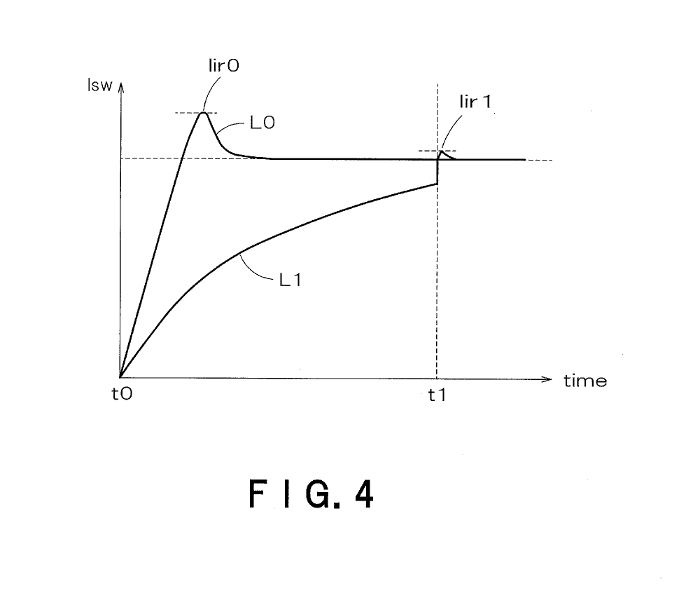

In this way, the load switch circuit LSW1 according to the first embodiment gradually charges the load LD1 using the first switching element 30 having a smaller current drive capability without causing a large inrush current to flow and then charges the load LD1 in a short time using the second switching element 40 having a larger current drive capability. Accordingly, even when the load capacitance LC1 is large, the load switch circuit LSW1 can suppress a large inrush current as shown in FIG. 4 and suppress a transitional decrease in the output voltage from the regulator REG.

FIG. 4 is a graph showing a current Isw at the time of switching. The vertical axis represents the current Isw and the horizontal axis represents the time. A line L0 indicates the current Isw supplied by a load switch circuit not including the first switching element 30 and the first controller 20. A line L1 indicates the current Isw supplied by the load switch circuit LSW1 according to the first embodiment.

When the first switching element 30 and the first controller 20 are not included (L0), the inverter 10 controls the single second switching element 40 and the single second switching element 40 supplies the current Isw. In this case, a large inrush current Iir0 flows as indicated by the line L0. When the inrush current Iir0 is large, the voltage Vout0 may be decreased greatly.

This leads to a malfunction of an electric device.

It is also conceivable that the discharge time of the gate capacitance of the second switching element 40 is prolonged by inserting a high resistance between the node N10 of the inverter 10 and the transistor 12. However, when the capacitance of the load LD1 is large, a large inrush current still occurs.

On the other hand, in the load switch circuit LSW1 according to the first embodiment, while the first switching element 30 for activation is brought to a conduction state during a period of times t0 to t1, the second switching element 40 for outputting is not brought to a conduction state yet. During this time period, the first switching element 30 gradually charges the load LD1. Subsequently, at the time t1, the second switching element 40 is also brought to a conduction state as well as the first switching element 30. Accordingly, the first switching element 30 and the second switching element 40 charge the load LD1 in a short time. At that time, because the first switching element 30 has charged the load LD1 to some extent before the time t1, an inrush current Iir1 occurring at the time t1 is smaller than the inrush current Iir0. As a result, a decrease in the voltage Vout0 is suppressed and a malfunction of the electric device can be suppressed.

In the first embodiment, the current drive capability of the first switching element 30 is smaller than that of the second switching element 40. However, the current drive capability of the first switching element 30 can be equal to or larger than that of the second switching element 40. For example, after the first switching element 30 for activation is brought to a conduction state during the period of times t0 to t1, the first switching element 30 and the second switching element 40 both become a conduction state after the time t1. In this case, the total current drive capability of both the first switching element 30 and the second switching element 40 is expected to be larger than the current drive capability of the single first switching element 30. Therefore, even when the current drive capability of the first switching element 30 is equal to or larger than that of the second switching element 40, the load switch circuit LSW1 can reliably cause a larger current to flow after the time t1 than at the time of activation during the period of times t0 to t1. However, in order to securely suppress an inrush current, it is preferable that the current drive capability of the first switching element 30 is smaller than that of the second switching element 40.

### Second Embodiment

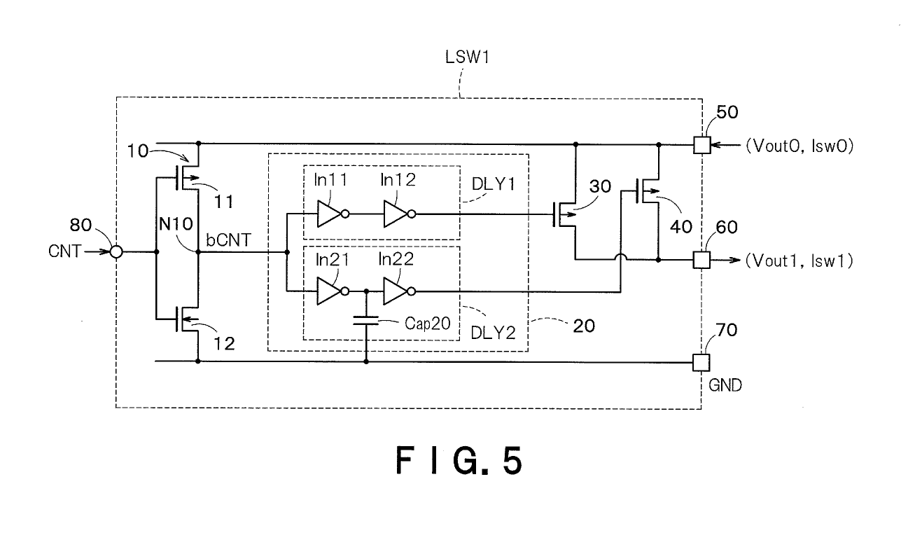

FIG. 5 shows an example of an internal configuration of the first controller 20 according to a second embodiment. Also in the second embodiment, the first controller 20 includes the first delay circuit DLY1 and the second delay circuit DLY2. However, the second embodiment is different from the first embodiment in that the second delay circuit DLY2 includes a delay capacitor Cap20. Other configurations of the second embodiment can be identical to corresponding ones of the first embodiment.

The delay capacitor Cap20 is connected between an input part of the inverter In22 and the ground part 70. More specifically, one of ends of the delay capacitor Cap20 is connected between the inverter In21 and the inverter In22 and the other end is connected to the ground voltage GND. Accordingly, in the second delay circuit DLY2, even when the inverter In21 outputs the reverse signal CNT, the inverter In22 does not output the control signal bCNT until the delay capacitor Cap20 is charged sufficiently to such an extent to operate the inverter In22. That is, the inverter In22 cannot output the control signal bCNT from a time when the inverter In21 outputs the reverse signal CNT until the delay capacitor Cap20 is sufficiently charged. The second delay circuit DLY2 thereby can output the control signal bCNT later than the first delay circuit DLY1.

A delay time of the second delay circuit DLY2 can be adjusted not only by the number of stages of inverters but also by the capacitance of the delay capacitor Cap20. Therefore, when the delay time of the second delay circuit DLY2 is longer than that of the first delay circuit DLY1, the number of stages of inverters in the second delay circuit DLY2 can be equal to or smaller than that in the first delay circuit DLY1. Of course, the number of stages of inverters in the second delay circuit DLY2 can be larger than that in the first delay circuit DLY1. That is, the second embodiment can be combined with the first embodiment. Other operations of the second embodiment can be identical to those of the first embodiment. Accordingly, the second embodiment can obtain effects identical to those of the first embodiment.

### Third Embodiment

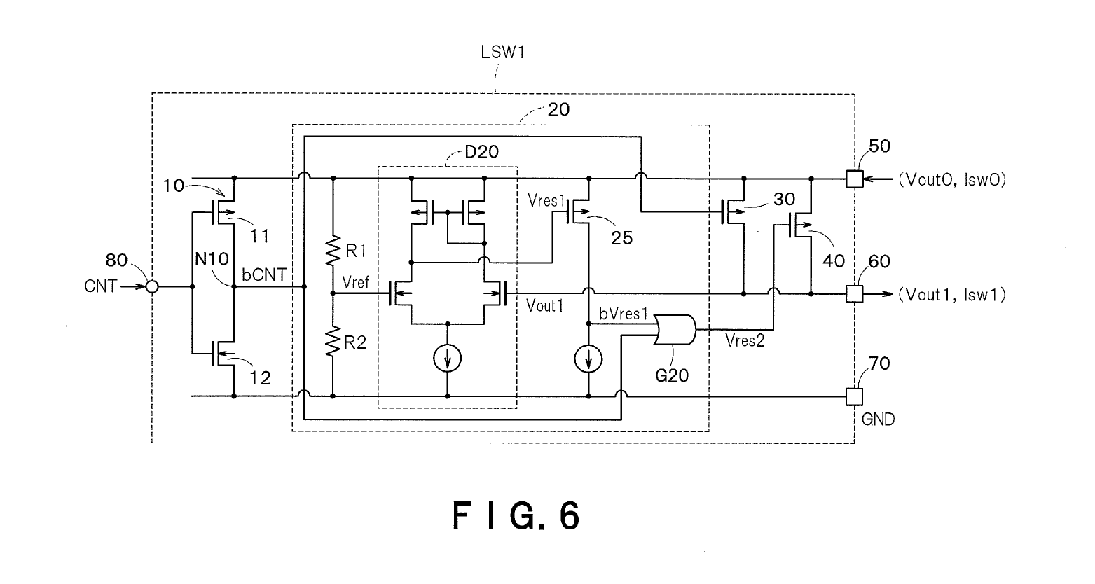

FIG. 6 shows an example of an internal configuration of the first controller 20 according to a third embodiment. In the third embodiment, the first controller 20 includes a differential amplifier D20, a logic circuit G20, resistors R1 and R2, and a P-transistor 25.

The differential amplifier D20 is connected between the input part 50 and the ground part 70 and compares the output voltage Vout1 from the output part 60 with a reference voltage Vref. The differential amplifier D20 outputs a comparison result signal Vres1 between the reference voltage Vref and the output voltage Vout1. The reference voltage Vref is obtained by dividing the input voltage (Vout0) from the input part 50 with the resistors R1 and R2 connected in series between the input part 50 and the ground part 70. The reference voltage Vref can be arbitrarily set within a range between the ground voltage GND and the voltage Vout0 according to a ratio between the resistors R1 and R2. For example, the reference voltage Vref can be set to about 80% of the voltage Vout0.

When the output voltage Vout1 is lower than the reference voltage Vref, the differential amplifier D20 sets the comparison result signal Vres1 at a logic low. When the output voltage Vout1 exceeds the reference voltage Vref, the differential amplifier D20 inverts the comparison result signal Vres1 to a logic high. In this way, the differential amplifier D20 monitors the output voltage Vout1 and inverts the logic of the comparison result signal Vres1 when the output voltage Vout1 exceeds the reference voltage Vref.

The transistor 25 is connected between the input part 50 and one of input parts of the logic circuit G20. A node between the transistor 25 and the logic circuit G20 is connected to the ground part 70 via a constant current source. A gate of the transistor 25 is connected to an output of the differential amplifier D20. The transistor 25 thereby supplies an inversion signal bVres1 (a first result signal) of the comparison result signal Vres1 to one of the input parts of the logic circuit G20.

For example, when the output voltage Vout1 is lower than the reference voltage Vref, the differential amplifier D20 sets the comparison result signal Vres1 at a logic low as described above and the transistor 25 sets the first result signal bVres1 at a logic high. On the other hand, when the output voltage Vout1 increases and exceeds the reference voltage Vref, the differential amplifier D20 inverts the comparison result signal Vres1 to a logic high and the transistor 25 sets the first result signal bVres1 at a logic low. In this way, when the output voltage Vout1 exceeds the reference voltage Vref, the transistor 25 inverts the logic of the first result signal bVres1 according to inversion of the logic of the comparison result signal Vres1. The first result signal bVres1 is used to control the second switching element 40 via the logic circuit G20.

The logic circuit G20 receives the first result signal bVres1 and the control signal bCNT as inputs and outputs an OR operation result Vres2 (a second result signal) thereof to the second switching element 40. The logic circuit G20 thereby controls the second switching element 40 using the first result signal bVres1 and the control signal bCNT.

An operation of the load switch circuit LSW1 according to the third embodiment is explained next in more detail. For example, when the control signal CNT is activated to a logic high to enable the load switch circuit LSW1 to supply power to the load LD1, the control signal bCNT becomes a logic low. This first brings the first switching element 30 to a conduction state. At that time, the output voltage Vout1 is still lower than the reference voltage Vref. Therefore, the control signal bCNT is at a logic low and the first result signal bVres1 is at a logic high. Therefore, the logic circuit G20 outputs a logic high as the second result signal Vres2 and the second switching element 40 keeps a non-conduction state.

On the other hand, when the first switching element 30 supplies power to the load LD1, thereby causing the output voltage Vout1 to gradually increase and exceed the reference voltage Vref, the first result signal bVres1 is inverted to a logic low while the control signal bCNT is kept at a logic low. Therefore, the logic circuit G20 sets the second result signal Vres2 at a logic low to bring the second switching element 40 to a conduction state. Accordingly, the second switching element 40 supplies a current to the load LD1 together with the first switching element 30.

As described above, according to the third embodiment, the first controller 20 brings the first switching element 30 to a conduction state and keeps the second switching element 40 in a non-conduction state from a time when the control signal CNT is activated to a logic high until the output voltage Vout1 exceeds the reference voltage Vref. At a time when the output voltage Vout1 then exceeds the reference voltage Vref, the first controller 20 inverts the logic of the first result signal bVres1 and the logic of the second result signal Vres2 to bring the second switching element 40 to a conduction state. That is, the first controller 20 controls the first switching element 30 and the second switching element 40 based on the output voltage Vout1 rather than the delay time. Accordingly, the load switch circuit LSW1 can bring the second switching element 40 to a conduction state after the output voltage Vout1 increases to the predetermined reference voltage Vref. This enables a more reliable suppression of an inrush current.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A semiconductor device comprising:
an input part receiving power from a power supply or a regulator;
an output part outputting power to a load;
a first switching element connected between the input part and the output part and supplying power from the input part to the output part;
a second switching element connected in parallel with the first switching element between the input part and the output part and supplying power from the input part to the output part; and
a first controller bringing the second switching element to a conduction state after bringing the first switching element to a conduction state when power is to be supplied to the load.

2. The device of claim 1, wherein the first switching element has a current drive capability smaller than that of the second switching element.

3. The device of claim 1, wherein
the first controller comprises:
a first delay circuit connected to the first switching element and outputting a control signal to the first switching element, the control signal controlling switching operation of the first and second switching elements; and
a second delay circuit connected to the second switching element and sending the control signal to the second switching element later than the first delay circuit.

4. The device of claim 2, wherein
the first controller comprises:
a first delay circuit connected to the first switching element and outputting a control signal to the first switching element, the control signal controlling switching operation of the first and second switching elements; and
a second delay circuit connected to the second switching element and sending the control signal to the second switching element later than the first delay circuit.

5. The device of claim 1, further comprising a second controller connected between the input part and a reference voltage source and controlling switching operation of the first and second switching elements via the first controller, wherein
the first controller comprises:
a first delay circuit connected between the second controller and the first switching element and sending a control signal from the second controller to the first switching element, the control signal controlling switching operation of the first and second switching elements; and
a second delay circuit connected between the second controller and the second switching element and sending the control signal from the second controller to the second switching element later than the first delay circuit.

6. The device of claim 2, further comprising a second controller connected between the input part and a reference voltage source and controlling switching operation of the first and second switching elements via the first controller, wherein
the first controller comprises:
a first delay circuit connected between the second controller and the first switching element and sending a control signal from the second controller to the first switching element, the control signal controlling switching operation of the first and second switching elements; and
a second delay circuit connected between the second controller and the second switching element and sending the control signal from the second controller to the second switching element later than the first delay circuit.

7. The device of claim 3, further comprising a second controller connected between the input part and a reference voltage source and controlling switching operation of the first and second switching elements via the first controller, wherein
the first controller comprises:
a first delay circuit connected between the second controller and the first switching element and sending a control signal from the second controller to the first switching element, the control signal controlling switching operation of the first and second switching elements; and
a second delay circuit connected between the second controller and the second switching element and sending the control signal from the second controller to the second switching element later than the first delay circuit.

8. The device of claim 5, wherein
the first delay circuit comprises at least an inverter connected between the second controller and the first switching element,
the second delay circuit comprises inverters connected between the second controller and the second switching element, and
number of the inverters included in the second delay circuit is larger than that of the inverter or inverters included in the first delay circuit.

9. The device of claim 5, wherein
the second delay circuit comprises:
at least two inverters connected between the second controller and the second switching element; and
a capacitor connected between one of input parts of the inverters and the reference voltage source.

10. The device of claim 8, wherein
the second delay circuit comprises:
at least two inverters connected between the second controller and the second switching element; and
a capacitor connected between one of input parts of the inverters and the reference voltage source.

11. The device of claim 1, wherein
the first controller comprises:
a differential amplifier comparing an output voltage of the output part with a reference voltage according to an input voltage of the input part, the differential amplifier outputting a first result signal of the comparison of the output voltage with the reference voltage; and
a logic circuit controlling the second switching element using the first result signal, and
the first controller brings the first switching element to a conduction state based on a control signal for controlling switching operation of the first and second switching elements, and then the first controller brings the second switching element to a conduction state when the first result signal is inverted.

12. The device of claim 2, wherein
the first controller comprises:
a differential amplifier comparing an output voltage of the output part with a reference voltage according to an input voltage of the input part, the differential amplifier outputting a first result signal of the comparison of the output voltage with the reference voltage; and
a logic circuit controlling the second switching element using the first result signal, and
the first controller brings the first switching element to a conduction state based on a control signal for controlling switching operation of the first and second switching elements, and then the first controller brings the second switching element to a conduction state when the first result signal is inverted.

13. The device of claim 11, wherein the logic circuit brings the second switching element to a conduction state based on a second result signal indicating a result of an operation carried between the control signal and the first result signal.

14. The device of claim 12, wherein the logic circuit brings the second switching element to a conduction state based on a second result signal indicating a result of an operation carried between the control signal and the first result signal.

15. The device of claim 13, wherein
the first controller brings the first switching element to a conduction state when logic of the control signal is inverted,
the differential amplifier inverts logic of the first result signal when the output voltage exceeds the reference voltage, and
the logic circuit inverts the second result signal to bring the second switching element to a conduction state when the logic of the first result signal is inverted after inversion of the logic of the control signal.

16. The device of claim 14, wherein
the first controller brings the first switching element to a conduction state when logic of the control signal is inverted,
the differential amplifier inverts logic of the first result signal when the output voltage exceeds the reference voltage, and
the logic circuit inverts the second result signal to bring the second switching element to a conduction state when the logic of the first result signal is inverted after inversion of the logic of the control signal.
